(19) United States
(12) Patent Application Publication
(10) Pub. No.: US 2026/0137229 A1
(43) Pub. Date: May 21, 2026

(54) SYSTEM AND METHOD FOR REDUCING RECOVERY TIME IN AN ATMOSPHERIC BOILER-BASED STEAM COOKER

(71) Applicant: STERLING MANUFACTURING LLC, Fort Wayne, IN (US)

(72) Inventor: Lon LEHMAN, Ft. Wayne, IN (US)

(73) Assignee: STERLING MANUFACTURING LLC, Fort Wayne, IN (US)

(21) Appl. No.: 19/395,800

(22) Filed: Nov. 20, 2025

Related U.S. Application Data
(60) Provisional application No. 63/722,767, filed on Nov. 20, 2024.
(60) Provisional application No. 63/722,793, filed on Nov. 20, 2024.
(60) Provisional application No. 63/722,806, filed on Nov. 20, 2024.

(51) Int. Cl. A47J 27/04; A47J 27/00

(52) U.S. Cl. CPC A47J 27/04; A47J 27/002; A47J 2027/043

(57) ABSTRACT

A steam cooking system includes a steam chamber, a door, a steam generator, a steam line, a steam valve, a vent/drain valve, and a controller. The steam chamber has an interior. The door is positioned on the steam chamber, and the door has an open position and a closed position. The steam line connects the steam generator to the interior of the steam chamber. The steam valve is positioned along the steam line. The vent/drain valve is mounted on the steam chamber in communication with the interior of the steam chamber. The controller is connected to and configured to operate the steam valve and the vent/drain valve. The controller operates the vent/drain valve to open when the door is in the open position, and operates the vent/drain valve to open periodically when the door is in the closed position.

### CROSS-REFERENCE TO RELATED APPLICATIONS

This application claims the benefit of priority to U.S. Provisional Ser. No. 63/722,767 , filed on Nov. 20, 2024, U.S. Provisional Ser. No. 63/722,793 , filed on Nov. 20, 2024, and U.S. Provisional Ser. No. 63/722,806 , filed on Nov. 20, 2024, which are hereby incorporated by reference in their entirety.

### TECHNICAL FIELD

This disclosure is directed to steam-based cookers that operate at or near atmospheric pressure.

### BACKGROUND

Steam-based cookers operate at or near atmospheric pressure and work well for their intended purpose. One characteristic of such cookers is that when a user opens a door of the steam-based cooker to remove or add food products, heat is released. After the user closes the door, it requires time for the temperature internal to the steam-based cooker to return to a desirable cooking temperature range.

### SUMMARY

This disclosure provides a steam cooking system including a steam chamber, a door, a steam generator, a steam line, a steam valve, a vent/drain valve, and a controller. The steam chamber has an interior. The door is positioned on the steam chamber, and the door has an open position and a closed position. The steam line connects the steam generator to the interior of the steam chamber. The steam valve is positioned along the steam line. The vent/drain valve is mounted on the steam chamber in communication with the interior of the steam chamber. The controller is connected to and configured to operate the steam valve and the vent/drain valve. The controller operates the vent/drain valve to open when the door is in the open position, and operates the vent/drain valve to open periodically when the door is in the closed position.

Advantages and features of the embodiments of this disclosure will become more apparent from the following detailed description of exemplary embodiments when viewed in conjunction with the accompanying drawings.

### BRIEF DESCRIPTION OF THE DRAWINGS

FIG. 1 shows a view of the steam cooker system in accordance with a first exemplary embodiment of the present disclosure, with elements represented schematically.

FIG. 2 shows a perspective view of a steam chamber or compartment of the steam cooker system of FIG. 1 in accordance with an exemplary embodiment of the present disclosure.

FIG. 3 shows a perspective view of a steam chamber of the steam cooker system of FIG. 1 in accordance with an exemplary embodiment of the present disclosure.

FIG. 4 shows a process flow of the steam cooker system of FIG. 1 in accordance with an exemplary embodiment of the present disclosure.

FIG. 5 shows a perspective view of a combination super-heater and manifold of the steam cooker system of FIG. 1 in accordance with an exemplary embodiment of the present disclosure.

FIG. 6 shows a perspective view of the combination super-heater and manifold of FIG. 6.

FIG. 7 shows a view of the steam chamber of FIG. 1 with the combination super-heater and manifold of FIGS. 5 and 6 attached to the steam chamber.

FIG. 8 shows an internal view of the steam chamber of FIG. 2.

FIG. 9 shows a view of a steam jet of the steam chamber of FIG. 2 in accordance with an exemplary embodiment of the present disclosure.

FIG. 10 shows another internal view of the steam chamber of FIG. 2.

FIG. 11 shows a further internal view of the steam chamber of FIG. 2.

### DETAILED DESCRIPTION

Boiler-based steam cookers are popular appliances used in the foodservice industry. Such steam cookers use a boiler to generate steam, and the steam is fed to the cooking compartment to cook food products positioned within the cooking compartment.

Boiler-based steam cookers are available to a user or consumer as either atmospheric or pressurized units. The inventor recognized that the design of the atmospheric boiler-based steam cooker, which operates at or near atmospheric pressure, creates a lag in time or an “increased recovery time” that occurs from when the cooking compartment door is closed to when steam is able to enter the cooking compartment to do work, i.e., to cook the food product. The systems described in this disclosure decrease the recovery time to increase the speed at which a designated cooking temperature is reached.

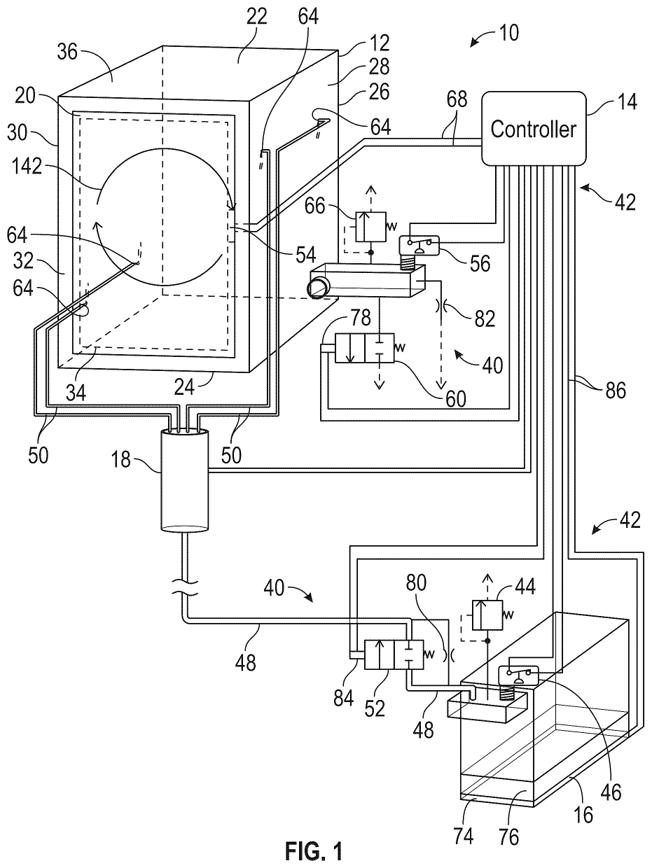

FIG. 1 shows a schematic view of steam cooker or steam cooker system 10 in accordance with a first exemplary embodiment of the present disclosure, with elements represented schematically. Steam cooker system 10 includes a plurality of elements that generate, release, and contain steam. Such elements include a steam chamber or cooking compartment 12, a controller 14, a steam generator 16, and a combination super-heater and manifold, which is referenced herein as a manifold 18.

Many aspects of the disclosure are described in terms of sequences of actions to be performed by elements of a computer system or other hardware configured to execute programmed instructions, for example, a general-purpose computer, special-purpose computer, workstation, or other programmable data processing apparatus. A person of ordinary skill should recognize that in each of the embodiments including active or electronic elements, the various actions could be performed by specialized circuits (e.g., discrete logic gates interconnected to perform a specialized function), by program instructions (e.g., software), such as logical blocks, program modules etc. being executed by one or more processors (e.g., one or more microprocessors, a central processing unit (CPU), and/or application specific integrated circuit), or by a combination of both. For example, embodiments can be implemented in hardware, software, firmware, middleware, microcode, or any combination thereof. The instructions can be program code or code segments that perform necessary tasks and can be stored in a non-transitory, machine-readable (e.g., computer-readable) medium such as a storage medium or other storage(s). A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents.

The non-transitory machine-readable medium can additionally be considered to be embodied within any tangible form of computer-readable carrier, such as solid-state memory, magnetic disk, and optical disk containing an appropriate set of computer instructions, such as program modules, and data structures that would cause a processor to carry out the techniques described herein. A computer-readable medium may include the following: an electrical connection having one or more wires, magnetic disk storage, magnetic cassettes, magnetic tape or other magnetic storage devices, a portable computer diskette, a random access memory (RAM), a read-only memory (ROM), an erasable programmable read-only memory (e.g., EPROM, EEPROM, or Flash memory), or any other tangible medium capable of storing information.

It should be noted that the systems of the present disclosure are illustrated and discussed herein as having various modules and units that perform particular functions. It should be understood that these modules and units are merely schematically illustrated based on their function for clarity, and do not necessarily represent specific hardware or software. In this regard, these modules, units, and other components may be hardware and/or software implemented to substantially perform their particular functions explained herein. The various functions of the different components can be combined or segregated as hardware and/or software modules in any manner and can be useful separately or in combination. Input/output or I/O devices or user interfaces, including but not limited to keyboards, displays, pointing devices, and the like, can be coupled to the system either directly or through intervening I/O controllers. Thus, the various aspects of the disclosure may be embodied in many different forms, and all such forms are contemplated to be within the scope of the disclosure.

Unless otherwise specified, any element or component included in this disclosure should be understood as being implemented as hardware. Thus, the controller disclosed herein is hardware, and the controller includes a hardware processor. The controller and/or processor are configured to execute instructions, and such instructions may be embodied as software.

Controller 14 may be connected by wires or wirelessly to various elements disclosed herein. Accordingly, the apparatus by which controller 14 communicates with the various elements disclosed herein should be understood by persons of ordinary skill in the controller arts.

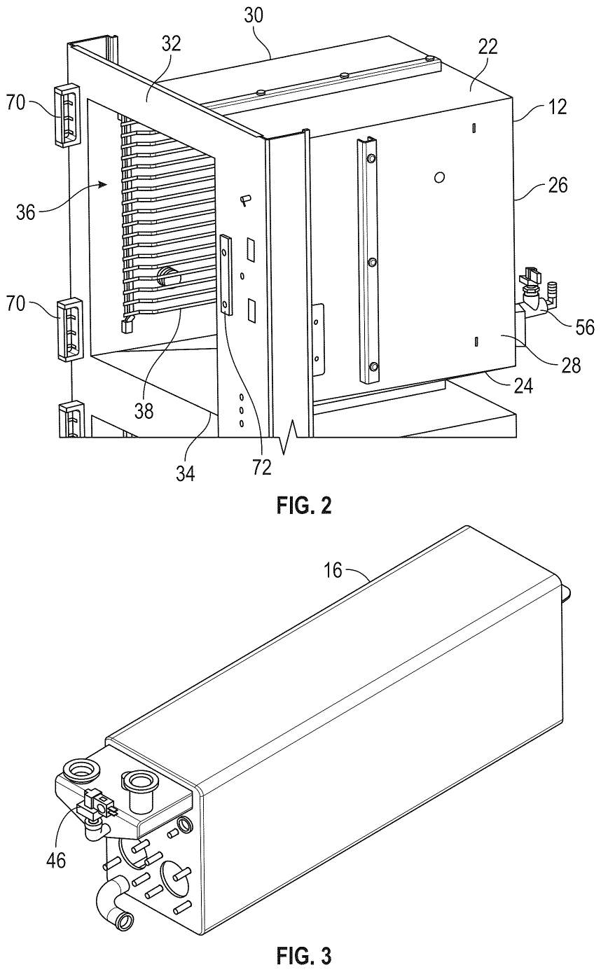

Steam chamber or cooking compartment 12, which may also be described as a compartment 12, includes a plurality of walls and a door 20. The plurality of walls can include a top wall 22, a bottom wall 24, a back wall 26, a first, right-side wall 28, a second, left-side wall 30, and a front wall 32. Door 20 can be attached to any wall by way of a variety of mechanisms, for example, by way of hinges 70, which may be seen in, for example, FIG. 2. Front wall 32 includes an opening 34. Door 20 is configured to cover opening 34 and to be sealed against front wall 32 such that steam chamber 12 is entirely enclosed, excluding fluid inlets and outlets disclosed herein. Door 20 is sealed against front wall 32 using a latching mechanism 72, a portion of which is shown in FIG. 2. Thus, an interior 36 of steam chamber 12, which may be described as a cooking compartment, is configured to contain steam that flows into interior 36, excluding fluid paths provided to intentionally exhaust such steam.

As shown in FIG. 2, steam chamber 12 may include a plurality of supports 38 configured to support one or more cooking trays (not shown).

Steam cooker 10 includes two subsystems that enable the functions of steam cooker 10. One subsystem is steam generation subsystem 40. Another subsystem is electronic subsystem 42. Steam generation subsystem 40 includes all components related to the generation of steam, transportation of steam to interior 36 of steam chamber 12, and release of steam from interior 36. Electronic subsystem 42 provides active control of the functions of steam generation subsystem 40.

Steam generation subsystem 40 includes steam generator 16. See FIG. 3 for a perspective view of an exemplary steam generator. Steam is generated within steam generator 16 by way of, for example, electric heaters 74 that heat water 76 within steam generator 16.

Steam generation subsystem 40 also includes a normally closed generator pressure relief valve 44, which opens to relieve pressure from steam generator 16 when the pressure in steam generator 16 exceeds a predetermined pressure, which can be in a range from 1-10 pounds per square inch (PSI). In an exemplary embodiment, the relief pressure is 5 PSI.

The pressure provided by steam generator 16 to steam chamber 12 is at or near atmospheric pressure. Thus, one goal of the systems disclosed herein is to limit pressure in steam chamber 12 to a relatively low level, which is defined in the context of this disclosure as being about 15 inches of water column or about 0.6 PSI. In the context of this disclosure, “about” means approximately 5 inches of water column, meaning that 20 inches of water column maximum is within the meaning of “about.” Similarly, 0.7 PSI maximum is within the range of “about 0.6 PSI.” One reason for permitting a higher level of pressure is to assure steam delivery through varying lengths and diameters of lines from steam generator 16 to steam chamber 12. Also, there may be minor unexpected leakages that can be compensated for with a slightly higher pressure in steam generator 16. Other pressures can be used, for example, any pressure in a range from 0-15 inches of water column. One predetermined pressure can be, for example, 10 inches of water column.

As noted above, steam generator 16 operates at relatively low pressures, including at atmospheric pressure. However, at least a small amount of pressure is desirable to force steam from steam generator 16 toward steam chamber 12. Accordingly, steam generator 16 of steam generation subsystem 40 also includes a generator temperature/pressure sensor 46 that measures the pressure within steam generator 16. The function of generator temperature/pressure sensor 46 is described in more detail herein.

Steam generation subsystem 40 also includes a steam line, conduit, or pipe 48 that connects steam generator 16 to manifold 18. Steam generation subsystem 40 further includes a plurality of steam lines, conduits, or pipes 50 that connect 18 to steam chamber 12. A normally closed steam valve 52, also included as part of steam generation subsystem 40, is positioned along steam line or pipe 48. As described further herein, steam valve 52 includes an electronic steam valve actuator 84 that is connected to controller 14. Once generator temperature/pressure sensor 46, which is electrically connected to controller 14, indicates the presence of steam pressure in steam generator 16, controller 14 actuates normally closed steam valve 52 to an open position to enable steam to travel from steam generator 16 through steam line or pipe 48 to steam valve 52, then along steam line or pipe 48 to manifold 18. Pressure sensor 46 determines whether there is sufficient pressure in steam generator 16 to cook food in steam chamber 12.

As described further herein, upon opening of door 20, controller 14 sends a signal to actuator 78 to deactivate steam valve 52, preventing flow of steam from steam generator toward manifold 18 and toward steam chamber 12.

When steam flows toward super heater and manifold 17, in manifold 18, steam is split into a plurality of steam lines or pipes 50 to a plurality of locations on steam chamber 12.

When door 20 is closed and latched in the closed position, a compartment door switch 54, which is part of electronic subsystem 42 and which is mounted on steam chamber 12, indicates that door 20 is closed and latched. Compartment door switch 54 can be any of a plurality of devices, including a magnetic switch, a mechanical plunger switch, a pressure plate switch, or other device configured to indicate that door 20 is in the closed position. The signal from compartment door switch 54 is sent to controller 14, which determines that steam valve 52 can be actuated to the open position to send steam from steam generator 16 to steam chamber 12.

Electronic subsystem 40 includes a compartment pressure switch 56 and an actuator 78 for a normally closed vent/drain valve 60. As will be described further herein, compartment pressure switch 56 sends an electronic signal to controller 14 indicative of the pressure in steam chamber 12, which is the pressure used for cooking. The pressure can be, for example, 10 inches of water column, though other values between 5 and 12 inches of water column can be used. Controller 14 is configured to send an electronic signal to normally closed vent/drain valve 60 to open vent/drain valve 60 to release pressure in steam chamber 12 under the situations disclosed herein.

Steam generation subsystem 40 also includes a plurality of steam jets 64. The plurality of steam jets 64 is positioned on interior surfaces of one or more of a plurality of walls 22, 24, 26, 28, 30, and 32 and is configured to establish cylindrical or circular steam or fluid flow within interior 36 of steam chamber 12 to improve uniformity of cooking, as disclosed in more detail herein.

Steam generation subsystem 40 further includes a normally closed compartment pressure relief valve 66. Compartment pressure relief valve 66 is configured to limit steam pressure within steam chamber 12 for safety. Steam chamber 12 is designed to handle the maximum pressure disclosed herein, with an additional safety margin. However, in the event of an unforeseen situation, compartment pressure relief valve 66 opens at a predetermined pressure, for example, at a predetermined value between 1-3 PSI, to release steam to help prevent excessive pressure within steam chamber 12. Door 20 also provides an inherent safety relief since door 20 is latched magnetically, and excessive pressure can cause the magnetic latch to release.

Also included as part of steam generation subsystem 40 is vent/drain valve 60. When door 20 begins to open, compartment door switch 54 closes, sending a signal through wires 68 to controller 14. Controller 14 then sends a signal to the actuator of vent/drain valve 60, opening normally closed vent/drain valve 60. Any pressure within steam chamber 40 is instantly released through vent/drain valve 60, such that pressure within steam chamber 12 drops to atmospheric pressure, thus preventing pressure from forcing door 20 open.

Steam generation subsystem 40 also includes an inlet bleed orifice 80 and an outlet bleed orifice 82. When the cooking compartment door 20 is opened, steam valve 52 is closed and inhibits the flow of steam to steam chamber 12, except for a minimal amount of steam allowed through inlet bleed orifice 80, which helps keep both steam generator 16 active and also keeps steam line 48 to the cooking compartment 12 warm. Outlet bleed orifice 82 serves to bleed air and steam from steam chamber 12, and also helps to keep steam refreshed within steam chamber 12. The release of air and steam from steam chamber 12 causes steam generator 16 to continuously generate saturated steam and helps to eliminate air pockets from forming in interior 36 of steam chamber 12. Any steam or water exhausted through vent/drain valve 60 or outlet bleed orifice 82 can be returned to steam generator 16 or to a separate sump or drain (not shown).

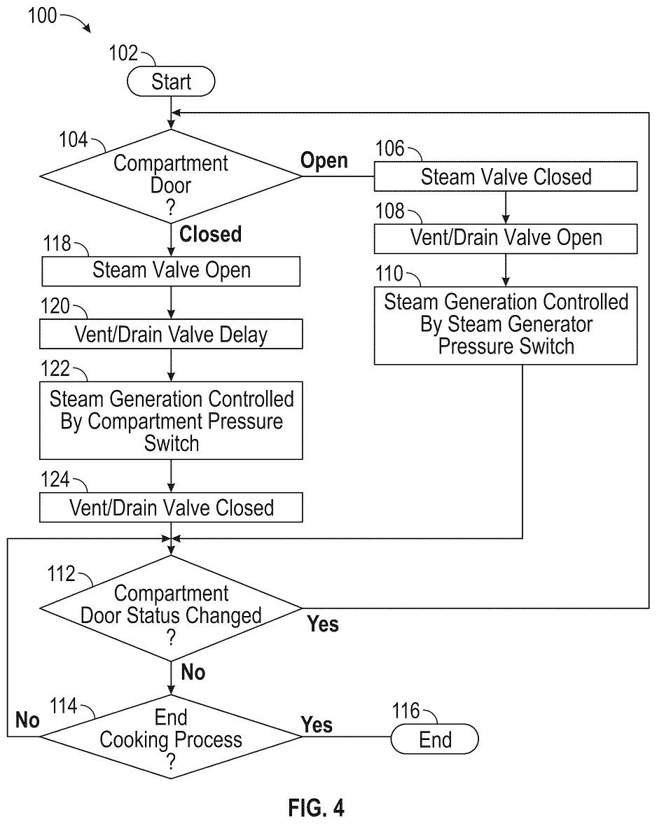

FIG. 4 shows an exemplary door opening process flow 100 of steam cooker 10. Process flow 100 begins during a normal cooking process 102 and passes to a compartment door status decision process 104. In compartment door status decision process 104, controller 14 determines whether door 20 is in an open or closed status based on whether compartment door switch 54 is closed or open. If door 20 is open, control passes from compartment door status decision process 104 to a steam valve process 106, where controller 14 operates steam valve actuator 84 to close steam valve 52, which is open during cooking process 102. Control then passes from steam valve process 106 to a vent/drain valve process 108.

In vent/drain valve process 108, vent/drain valve 60, which is closed during cooking process 102, is opened by controller 14 by way of actuator 78. Control then passes from vent/drain valve process 108 to a steam generation control process 110.

In steam generation control process 110, steam generation in steam generator 16 is controlled by signals from generator temperature/pressure sensor 46 sent to controller 14. If there is insufficient steam in steam generator 16, then controller 14 sends signals to heater 74 by way of wires 86 connecting controller 14 to heater 74 to increase the heat output of heater 74. Such control is continuous in that the output of generator temperature/pressure sensor 46 is constantly monitored by controller 14, and the output of heater 74 is constantly adjusted to increase or decrease the output of heater 74 to maintain a target pressure in heat generator 16.

During the time door 20 is open, steam valve 52 is closed and inhibits the flow of steam to the cooking compartment, with the exception of a minimal amount of steam allowed through inlet bleed orifice 80, which helps keep both the steam generator active and also keep the steam lines to the compartment warm. At this time, the temperature and/or pressure of the steam in the boiler is maintained at an elevated level as measured by pressure and/or temperature sensor 46 connected to the boiler. It should be noted that the condition of steam in steam generator 16 can be controlled by temperature, pressure, or both.

In the context of this disclosure, the term “elevated pressure” means a pressure greater than or equal to the nominal pressure of steam generator 16. For example, if the steam generator pressure is at 2 inches water column during cooking operation when door 20 is closed and steam valve 52 is open, when door 20 is open and steam valve 52 is closed, pressure can build in steam generator 16 to the level permitted by generator pressure relief valve 44, which can be, for example, fixed at 5 PSI, though the specific pressure relief value can be in the range 2-10 PSI.

Control then passes from steam generation control process 110 to a compartment door status process 112.

In compartment door status process 112, controller 14 determines from signals sent by compartment door switch 54 whether door 20 has switched from the open position to the closed position. If door 20 remains open, control passes from compartment door status process 112 to an end cooking decision process 114.

In end cooking decision process 114, controller 14 determines whether a command has been entered to stop cooking. Such a command may be entered by, for example, a user of steam cooker 10. Such a command may also be entered by a safety system in the event of certain types of failures, such as overpressure, overtemperature, lack of water in steam generator 16, etc. If such a command has been entered, which is by way of an input not shown, control passes to an end process 116. In end process 116, controller 14 stops the operation of electric heater 74, vent/drain valve 60 is moved to the open position by actuator 78, and steam valve 52 is moved to the closed position by steam valve actuator 84. Controller 14 may perform other functions during shutdown.

Returning to end cooking decision process 114, if a command to stop cooking has not been entered, control passes to compartment door status process 112, which operates as described elsewhere herein. Control loops from compartment door status process 112 to end cooking decision process 114 until the status of door 20 changes.

When the status of door 20 changes, control passes from compartment door status process 112 to compartment door status decision process 104. In compartment door status decision process 104, controller 14 determines that not only has the status of door 20 changed, but the status has changed from door open to door closed. Control then passes from compartment door status decision process 104 to a series of processes that enable rapid recovery from door 20 being open to load food product to be cooked and/or to remove cooked food product. Control initially passes from compartment door status decision process 104 to a steam valve open process 118.

In steam valve open process 118, controller 14 actuates steam valve actuator 84 to open steam valve 52. Control then passes from steam valve open process 118 to a vent/drain delay process 120. In vent/drain valve delay process 120, there is a delay after the opening of steam valve 52 before drain valve 60 is closed. During vent/drain valve delay process 120, the pressure in steam generator 16 causes steam to flow from steam generator 16 along pipe 48 through steam valve 52, then through manifold 18, followed by pipes 50, to interior 36 of steam chamber 12. Steam rapidly builds in interior 36 to restore a cooking temperature to interior 36 during the interval or delay between the opening of steam valve 52 and the closing of drain valve 60. The delay can be, for example, in a range from 1-30 seconds, providing a flushing effect of air in interior 36 with steam from steam generator 16 to quickly rebuild steam and heat within interior 36. In another embodiment, the range can be from 5-30 seconds. In yet another embodiment, the range can be from 7-30 seconds. In still another embodiment, the range can be from 7-25 seconds. Indeed, the length of the delay can be variable based on how long the door is opened, and can be any value in the range from 1 second to 60 seconds. However, a specific predetermined value can also be used, for example, 8 seconds, or any specific predetermined value between 1 second and 60 seconds. However, shorter is generally preferred for the sake of energy efficiency. So, a predetermined value in a range from 5-10 seconds is a desirable embodiment. Once the delay interval has passed, control passes from drain valve process 120 to a steam generation process 122.

In steam generation process 122, controller 14 adjusts the temperature of heater 74, if needed, to restore temperature and pressure in steam generator 16, as measured by pressure sensor 46. Control then passes from steam generation process 122 to a vent/drain valve closing process 124.

In vent/drain valve closing process 124, drain valve 60 is closed by signals sent from controller 14 to actuator 78. At this time, the temperature in interior 36 is near or at the nominal cooking temperature for food products, which is at or slightly above 212 degrees Fahrenheit. In conventional systems, it requires significant time for the temperature in interior 36 to be restored since steam requires significant time in conventional systems to transfer from steam generator 16 to interior 36.

After drain valve closing process 124, control passes drain valve closing process 124 to compartment door status process 112, which functions as described herein.

During cooking operation, it can be beneficial to periodically open drain valve 60 for 5 to 180 seconds without closing steam valve 52. Thus, drain valve 60 is operated at two separate times during cooking operation. One time is when door 20 is opened. The other time is during cooking operation with door 20 closed. One benefit of opening drain valve 60 with door 20 closed is that condensed water from the bottom of interior 36 is drained before door 20 is opened, reducing the risk of water exiting door 20 when door 20 is opened.

During cooking, with door 20 closed, drain valve 60 can be opened at intervals of 1 to 30 minutes, at the aforementioned opening times from 5 to 180 seconds, which helps eliminate condensed water from interior 36. The modes of operation disclosed in this paragraph are generally independent of the opening and closing of door 20, as well as being independent of the closing of steam valve 52.

It should be noted that the interval at which drain valve 60 is opened during cooking can vary, depending on how often condensed water needs to be drained or how often steam replenishment is beneficial. For example, drain valve 60 can be opened for 8 seconds every 25 minutes, every 15 minutes, every 10 minutes, or every 5 minutes, or any predetermined interval in a range from 1 to 30 minutes. The opening time can also be at any predetermined value in a range from 5 to 180 seconds. For example, drain valve 60 can be open for 30 seconds at each predetermined interval.

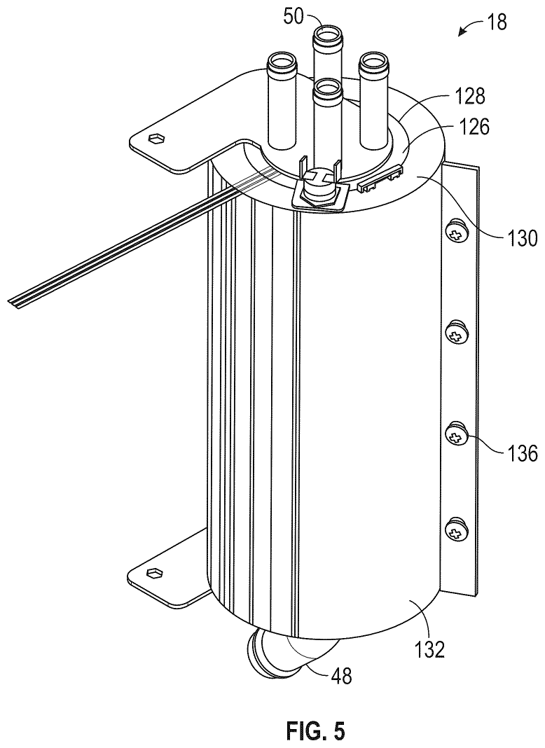

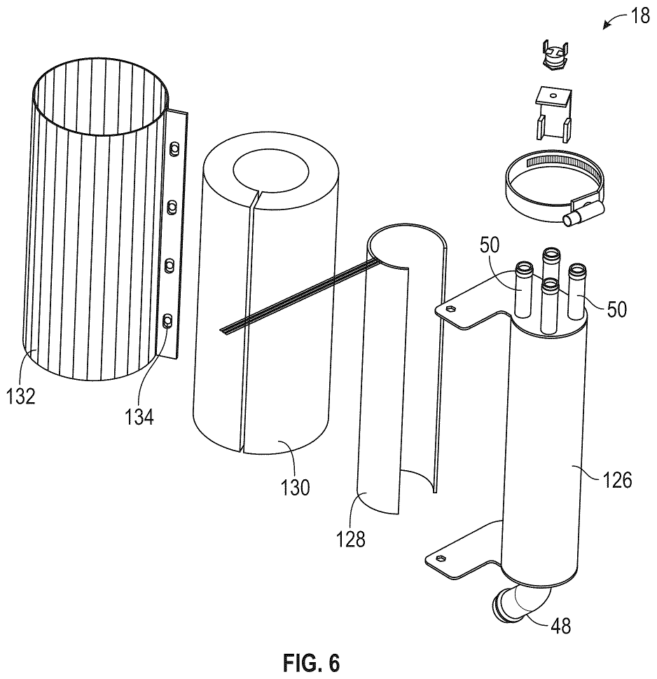

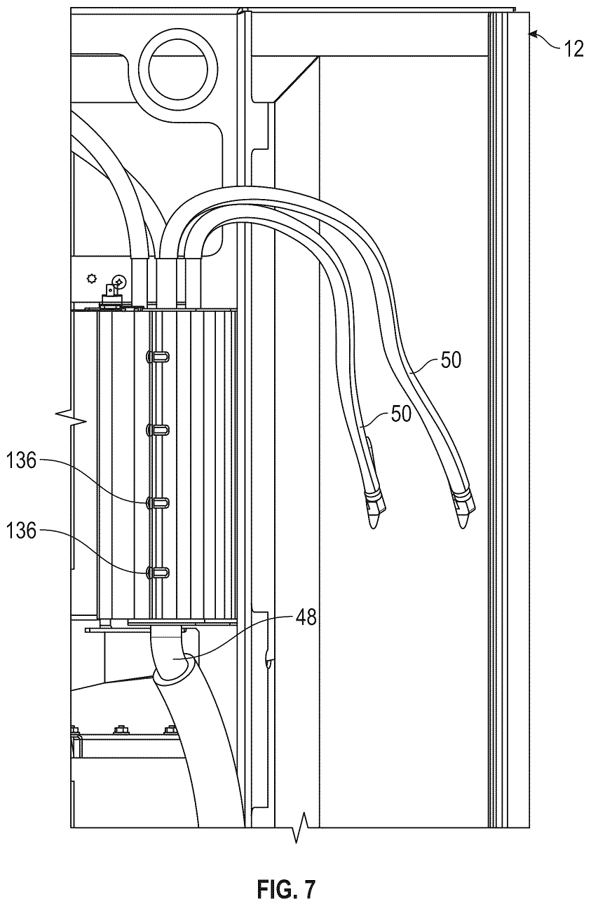

As disclosed herein, steam cooker 10 includes a combination super-heater and manifold, labeled manifold 18 for simplicity of description. Referring to FIGS. 1 and 5-7, manifold 18 is remotely located from steam generator 16, and is positioned much closer to steam chamber 12 than to steam generator 16. Much closer means that manifold 18 can be positioned as part of steam chamber 12. As steam travels from steam generator 16 to steam chamber 12, pressure and temperature can fall to the point where condensation can occur. To “dry” the steam, meaning restoring the temperature of the flow from steam generator 16 to steam chamber 12 to above the steam temperature of water, manifold 18 includes a heating element that adds heat to the steam flowing from steam generator 16 to steam chamber 12.

Manifold 18 includes a chamber 126, a flexible heater 128, a ceramic insulator 130, and a wrap mount 132. Chamber 126 is directly connected to pipe 48. Internal to chamber 126, the steam flowing into chamber 126 is split into a plurality of pipes 50, thus functioning as a manifold for steam flowing from steam generator 16. The function of steam flow into pipes 50 is discussed in more detail herein.

Flexible heater 128 is wrapped around chamber 126. Controller 14 provides power and control of flexible heater 128 to directly heat chamber 126 at temperatures greater than 212 degrees Fahrenheit, thus “drying” or elevating the temperature of steam flowing into chamber 126 such that any condensation in chamber 126 is converted back into steam. Ceramic insulator 130 is wrapped around flexible heater 128 to prevent user contact with flexible heater 128 for safety. Additional insulation may be provided as needed to reduce the risk of contact with pipe 48, chamber 126, and pipes 50. Wrap mount 132 is wrapped around ceramic insulator 130, flexible heater 128, and chamber 126, and can function to hold these components together as an assembly, as well as providing a plurality of openings 134 for fasteners 136 to secure 132 to the other components through frictional force.

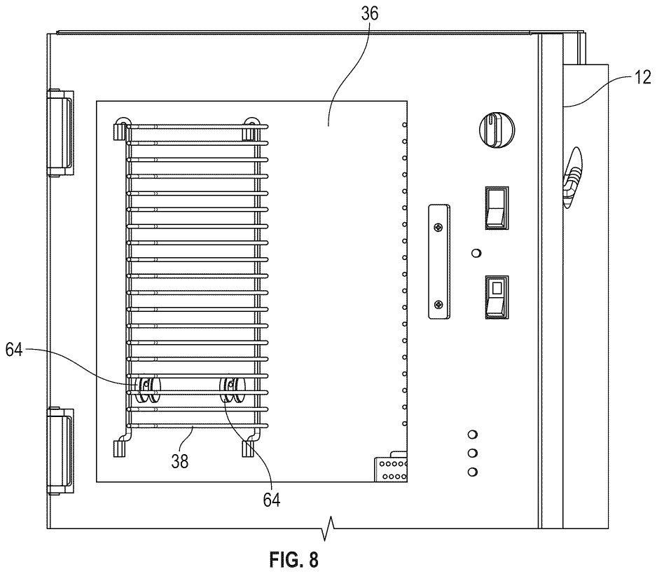

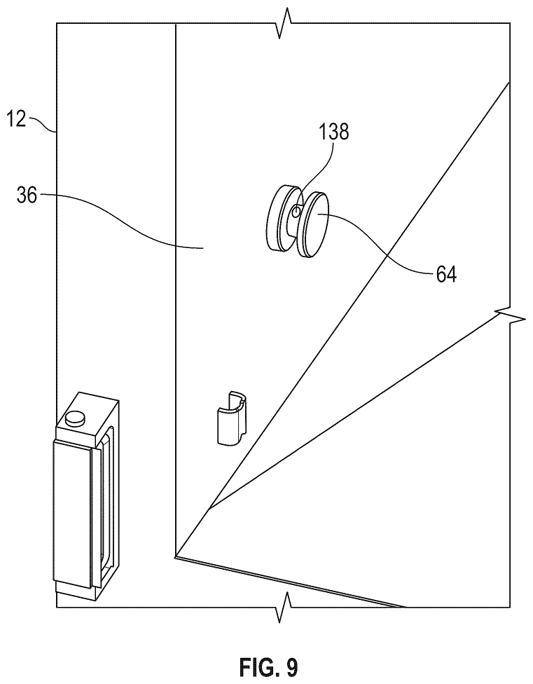

FIGS. 8-11 show views of interior 36 of steam chamber 12. Each of pipes 50 is connected to a respective plurality of steam jets 64 positioned and attached to one interior wall of steam chamber 12. In an embodiment, there are four steam jets 64. Two of the plurality of steam jets 64 can be located, for example, closer to a bottom of interior 36 than a top of interior 36 on a left interior wall of interior 36. Two of the plurality of steam jets 64 can be located, for example, closer to a top of interior 36 than a bottom of interior 36 on a right interior wall that forms interior 36.

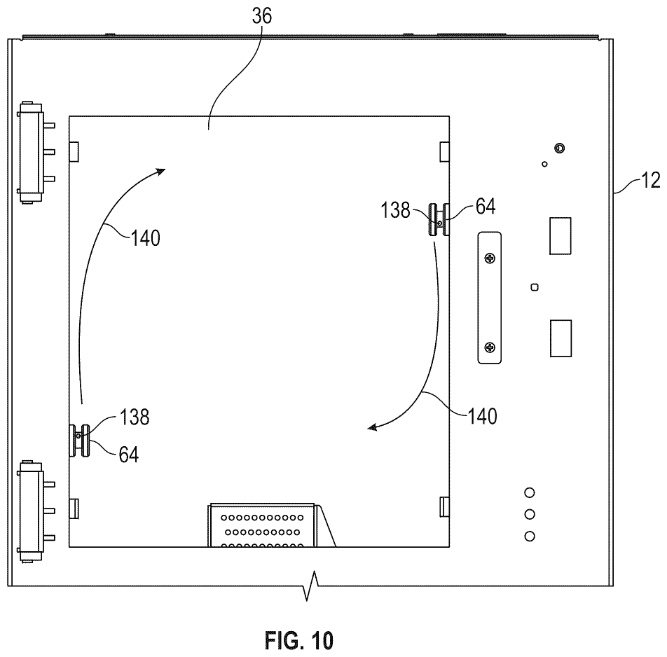

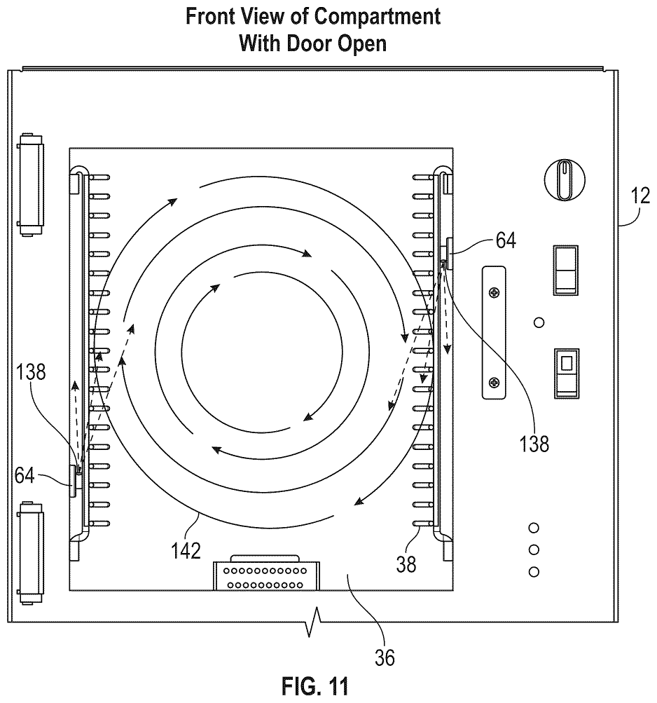

Each steam jet 64 includes an opening or port 138. Each of the lower steam jets 64 on the left side has an upward-facing port 138, and each of the upper steam jets 64 on the right side has a downward-facing port 138. Each of ports 138 exhausts steam in a direction that is along a respective interior surface of the walls that form interior 36. The effect of the positions of ports 138 can be seen in FIG. 10, where a steam flow 140 is established by ports 138. The result of steam flow 140 can be seen in FIG. 11, where steam flow 140 creates a steam vortex 142. Steam vortex 142 causes steam to circulate throughout interior 36, leading to more uniform cooking of food product within interior 36 as opposed to a single inlet or an inlet perpendicular to an interior wall.

While various embodiments of the disclosure have been shown and described, it is understood that these embodiments are not limited thereto. The embodiments may be changed, modified, and further applied by those skilled in the art. In addition, embodiments can be combined as a person of ordinary skill in the art should understand. Therefore, these embodiments are not limited to the details shown and described previously but also include all such changes and modifications.

I claim:

1. A steam cooking system, comprising:
a steam chamber having an interior;
a door positioned on the steam chamber having an open position and a closed position;
a steam generator;
a steam line connecting the steam generator to the interior of the steam chamber;
a steam valve positioned along the steam line;
a vent/drain valve mounted on the steam chamber in communication with the interior of the steam chamber; and
a controller connected to and configured to operate the steam valve and the vent/drain valve, the controller operating the vent/drain valve to open when the door is in the open position, and operating the vent/drain valve to open periodically when the door is in the closed position.
